(19) United States
(12) Patent Application Publication
(10) Pub. No.: US 2018/0070561 A1
(43) Pub. Date: Mar. 15, 2018

(54) MEMBRANE DISC DOG TOY

(71) Applicant: Julius-K9, LLC, Riverview, FL (US)

(72) Inventor: Gyula SEBÖ, Szigetszentmiklos (HU)

(21) Appl. No.: 15/648,442

(22) Filed: Jul. 12, 2017

(30) Foreign Application Priority Data
Sep. 13, 2016 (HU) U1600236
Jan. 11, 2017 (EP) 17 00 0042

(51) Int. Cl. A01K 15/02

(52) U.S. Cl. CPC A01K 15/026

(57) ABSTRACT

A membrane disc dog toy includes a hollow bite body, a handle, and a membrane disc covered by an outer cover of the bite body, formed in the continuation thereof, and dividing a cavity portion into two parts. The membrane disc elastically offsets the forces arising from the bite of the dog, acting perpendicularly to the longitudinal axis line ensuring the dimensional stability of the contour defined by the outer cover. The membrane disc protects the fixing end element of the handle led through the membrane through an opening from the direct forces arising from the bite of the dog. The membrane disc stretches up to the outer cover as a function of the forces acting through the handle, thereby reducing the shock on the joints of the dog and the person holding the handle while playing with the dog.

### CROSS-REFERENCE TO RELATED APPLICATION(S)

This application claims priority to Hungary Patent Application U1600236 filed Sep. 13, 2016 and European Patent Application EP 17 00 0042 filed Jan. 11, 2017, the disclosures of which are incorporated herein in their entirety by specific reference thereto.

A membrane disc dog toy comprising a hollow bite body and a handle, and a membrane disc covered by an outer cover of the bite body, formed therefrom, in the continuation thereof, most preferably perpendicularly to the longitudinal axis line, dividing a cavity portion into two parts, said membrane disc elastically offsets the forces arising from the bite of the dog, acting perpendicularly to the longitudinal axis line, ensures the dimensional stability of the contour defined by the outer cover, and said membrane disc protects the fixing end element of the handle led through the membrane through opening from the direct forces arising from the bite of the dog, from wearing out caused by the bite of the dog. The fixing end element of the handle is fixed by passing through the membrane through opening, furthermore the membrane disc stretches up to the outer cover as a function of the forces acting through the handle, thereby reduces the shock on the joints of the dog and the person holding the handle while playing tug-of-war with the dog.

Playing with the dog serves to bring out the most basic instincts of the dog. At the same time, playing with the dog has a positive, one might say personality-forming effect on the dog owner. While playing, happiness hormones are released in both parties, therefore dogs are used successfully in practice worldwide as perfect therapists for people with mental disabilities, depression, or suffering a musculoskeletal accident. There is a need, however, for making untrained dogs suitable for helping ill people through playing. It is a fact, nevertheless, that when playing with dogs some basic rules need to be followed in most cases, to make the game interesting for the dog as well. If we can develop a device suitable for being grabbed by the dog with its teeth, and also suitable for being held by the dog owner or the treated person in such a way that the teeth of the dog do not accidentally pose a danger to the person holding the device, then we can witness a carefree game. This so called tug-of-war game, aimed on the part of the dog at acquiring the target, gives a body-to-body experience and relaxation to both parties,

Even with the conscious pairing of the weight and strength of the playing parties, many forces arising from the pulling, tugging of the dog trying to acquire the target act on the hand, shoulder, spine of the person holding the handle of the target. The unexpected forces, the multitude of micro-vibrations can cause injury or pain to the arm, waist of the dog owner or the treated person. The same forces act on the neck of the dog as well, and can cause injury to a puppy or an older dog. Prior art toys are unable to reduce, offset such forces. Furthermore, a toy is interesting, desirable and engaging for dogs only if the prey moves in their direction when pulled. This positive reinforcement leads to the development of the tug-of-war skills and the play instinct itself for every dog.

However, the dog owner or treated person cannot be expected to react to the movements of the dog correctly and in a timely manner while playing, to handle the situation similarly to a person experienced in the profession. A dog toy designed to be suitable for elastic stretching while playing tug-of-war allows the person holding the handle to motivate the dog to play without being experienced in this activity. The aim is to allow people with disabilities to play freely with a dog, whether or not owned by them, on a daily basis, often unconsciously pushing themselves beyond their physical and mental limits. The set aim could be achieved by a dog toy with an internal structure capable of limited stretching that protects the joints of the person from physical impacts, and at the same time motivates the dog to play the game for an extended period of time. The happiness of a dog is proven to be captivating, and has a very positive effect on ill people. The most intense and safest generator for transferring the mood could be a dog toy comprising a handle known from the prior art, allowing a secure grip, and a bite body grabbed happily by the dog, where said dog toy is dimensionally stable, but suitable for limited stretching. The membrane disc dog toy allows a game in which there is very close physical contact between the dog and the person, without being physically demanding on the person. The dog is inspired to continue playing by the elastic stretching caused by the forces exerted by it. So the game remains enjoyable for the dog even if the person holding the handle holds the device passively, without making the “easing”, motivating movements used in dog training,

The attention of the dog owner or the person receiving the therapy is engaged by the close contact with the dog to the maximum. Under proper trainer supervision it is very effective in lifting inhibitions for people with serious illnesses, physical disabilities, or even depression. It is important, however, that the connection between the dog toy and the handle shall not be associated with any risk of the handle being torn out, because that can be dangerous to the health of, or a disastrous experience for the person receiving the therapy. Therefore the handle shall be fixed in the hollow body of the dog toy in a way which, due to the membrane disc support, prevents the dog from clenching its jaws on it, destroying it. When playing regularly, the design of the handle and the bite portion shall protect the person receiving the therapy from the physical impacts caused by the micro-vibrations and the tugging.

The tug-of-war game shall be interesting and rewarding for the dog even if the treated person is only capable of rigidly holding the handle of the dog toy. The internal design of the dog toy shall make it suitable for engaging the attention of the dog for up to 10-20 minutes while playing tug-of-war, even when it is attached to a fixed landmark, for example a braked wheelchair. The elasticity of the dog toy is most preferably provided by a membrane disc formed inside the bite body, because this way the extent of the stretching of the handle inside the cavity portion is highly controllable by the thickness of the membrane disc, and the stretching can be limited by the outer wall of the bite body.

A further aim is to prevent the compression, destruction of the fixing end element of the handle by the membrane disc. This way the fixing end element, which is usually a knot on the handle, can be prevented from being undone, destroyed by the compressive force of the bite of the dog.

The dog toy, as the target, is most preferably made of natural caoutchouc, silicone or TPE plastic by the injection moulding or baking process. The prior art includes several dog toys with a hollow interior and an elastic outer wall. Patent No. US20070289553A1 discloses a treat dispenser for dogs. In this case there is a helically extending insert in the hollow interior. The invention discloses the most preferred embodiments of a helically extending insert for receiving and dispensing treats hidden in the hollow interior of a dog toy.

The patent does not cover the fixing of a handle, the handle is held directly by the outer wall of the device, with the wear or the excessive stretching of the outer wall leading to the handle being torn out.

A close prior art solution is disclosed in patent No. US2010/0147228 A1.

In this case a motivational object comprises a handle portion, and it is fixed in a manner extending beyond the outer cover of a bite body. The essence of the invention is that the cavity portion of the device is covered on one side by an openable closing element suitable for hanging the device for example on human clothing. The handle is led through the outer wall and is fixed in the cavity portion, using the outer wall as a holding portion. A disadvantage of the patent is that the handle is held directly by the outer wall of the device, with the wear of the outer wall leading to the handle being torn out. In the event of the stretching of the outer wall the fixing end element is torn out from the cavity portion. If the outer wall is damaged, the fixing end element becomes directly accessible to the teeth of the dog. The device is not suitable for absorbing the micro-vibrations generated while playing. The stretching of the outer wall holding the fixing end element is not limited. When the outer cover is made of a softer material, although the elasticity of the handle increases, due to the forces acting on the handle, the fixing end element will be inevitably torn out. The middle portion of the bite body is not stiffened by an element against the compressive force arising from the bite of the dog, acting perpendicularly to the longitudinal axis line. The device can be used efficiently and without the risk of accidents only by persons experienced in playing with dogs. A dog owner not familiar with the principles of the predatory (tug-of-war) game, or physically incapable of playing it, will not be able to maintain the interest of the dog. The dog will be interested only in the treat placed inside the device. Neither the elastic, precisely limited stretching of the handle, nor the internal reinforcement perpendicularly to the longitudinal axis line is implemented in the patent.

Patent No. US2015 0296747A1 discloses a dog toy made preferably of rubber comprising a plurality of members, constructed to be dismantled by the dog, thus allowing the dog to gain access to the treat placed inside. The aim of the development is to engage the dog without the owner of the dog being present. The dog is engaged by dismantling the prey-toy, thus it has a skill development effect. The development is basically not aimed at the development or the playing of the tug-of-war (predatory) game. The toy does not have an element that would be capable of reducing the acting forces or the shock-like load on the joints, or would be capable of stretching through the handle without affecting the outer cover,

The closest solution to the utility model is presented in U.S. Pat. No. 5,865,146 A (Markham), disclosing a device comprising an elongated hollow body narrowing in the middle, with first and second bulbous sections each including respective first and second openings at the longitudinal ends for leading through the handle and fixing the fixing end element of the handle. The fixing end element is held inside the hollow body of the dog toy by the narrowed portion of the bite body.

A disadvantage of the development is that the narrowed portion holding the fixing end element forms a part of the outer cover defining the outer contour of the dog toy. The load of up to a ton arising from the bite of the dog can compress the fixing end element, and even the teeth of the dog can reach it by penetrating the outer cover. The teeth of the dog can damage the narrowed portion holding the fixing end element directly, the forces act on the fixing end element directly, possibly deforming it, and in the event of the perforation of the outer cover the fixing end element is worn out and torn out from the dog toy. While biting, the dog clenches its teeth on the fixing end element holding the handle. Therefore the narrowed portion forming a part of the outer cover is not suitable for protecting the fixing end element from deformation and from being torn out in the long-term. The fixing of the fixing end element in a manner involving such risks excludes the possibility of using the device (for tug-of-war purposes) safely, especially for mentally or physically disabled people. The primary aim of elastic, hollow dog toys is to be compressible by the dog, but to prevent permanent deformation caused by the bite. Another disadvantage of the patent is that the internal arrangement does not prevent the total compression of the cavity portion. The elasticity, dimensional stability of the device is determined only by the thickness and material of the outer cover, which excludes the possibility of the economical use of materials. The hollow body of the device is not stiffened at the height of the fixing end element by an element (membrane disc) approximately perpendicular to the longitudinal axis line. With the perforation, wearing out of the outer cover, the provision of a dimensionally stable elastic design is not solved. A tug-of-war-game for therapeutic purposes, sparing the joints of both the person and the animal, is not possible. A variable length handle portion is not possible in the cavity portion, as while the dog is biting, the narrowed portion is compressed on the fixing end element, thus the handle portion is fixed in the cavity portion in a fix manner, excluding elastic displacement. The device disclosed in the patent is not suitable for stretching to a predetermined length within the cavity portion as a result of the forces acting on the handle. The narrow portion of the device disclosed in U.S. Pat. No. 5,865,146, holding the fixing end element, is located in the middle portion of the device. This is not a prerequisite for the operation of the membrane disc, the limitation of its stretching by the outer wall. In the case of all the patents disclosed in the prior art, the outer cover withstands directly the forces acting on the handle while playing tug-of-war, and simultaneously the bite of the dog as well. The development of forming a membrane disc by the confluence of materials to increase the elasticity of the outer cover, to hold the fixing end element, to protect it from the bite of the dog, and to compensate the pulling force acting on the handle in a membrane-like manner, complicating the production process, is not obvious in view of either any of the patents, or all of them.

The task is to eliminate the above shortcomings, to develop an elastic handle portion—working together with a membrane disc—stretching to a limited extent, over a given section. The task is to prevent the fixing end element from being torn out, by forming a membrane disc inside. The task is to reduce the thickness of the outer cover in a cost-effective manner, and to stiffen the outer cover by a membrane disc. At least 70% of the membrane disc shall be formed from the outer wall of the bite body, in the continuation thereof. The task is to optimize the stretching of the membrane disc in response to a pulling force by increasing or decreasing the thickness of the membrane disc. The task is to form the membrane disc in a manner to be perpendicular to the longitudinal axis line, or to extend towards the cavity portion, thereby increasing the maximum length of the variable length handle portion. The task is to compensate the forces arising from the bite of the dog, acting perpendicularly to the longitudinal axis line, to counteract them elastically by the optimal positioning and thickness of the membrane disc. The task is to protect the joints of the dog and the person holding the device, to reduce the physical load on the bones and the joints.

A membrane disc dog toy comprising a handle and an elastic bite body, where the contour of said bite body is defined by an outer cover directly exposed to the bite of the dog, and said bite body comprises a cavity portion having at least one through opening and a handle through opening around the longitudinal axis line, and said handle extending beyond the outer cover has a fixing end element fixed in the cavity portion.

The essence of the development is that a membrane disc is formed from the outer cover, fully covered by the outer cover, connected to the outer cover in a connecting portion in a curved manner by the confluence of materials, supporting the outer cover, and said membrane disc separates a closed cell portion from the cavity portion on the side towards the handle through opening, furthermore there is a membrane through opening in the membrane disc around the longitudinal axis line, which is connected with the handle through opening on the opposite side of the closed cell portion around the longitudinal axis line by a variable length handle portion of the handle of the membrane disc dog toy passing through the closed cell portion in the direction of the longitudinal axis line, furthermore the variable length handle portion is led through the membrane through opening and ends in a fixing end element covering the membrane through opening on the side towards the cavity portion, furthermore the membrane disc stretches in the direction of the handle through opening as a function of the pulling force acting on the handle, and the maximum stretching of the membrane disc in the closed cell portion is limited by the surface towards the closed cell portion of the outer cover towards the handle through opening, furthermore the membrane disc controls the compression of the closed cell portion and the cavity portion in the direction perpendicular to the longitudinal axis line, elastically preventing their permanent deformation.

Most preferably, the diameter of the closed cell portion of the membrane disc dog toy perpendicular to the longitudinal axis line is larger in the line of the membrane disc than the diameter of the dosed cell portion on the side opposite to the membrane disc, containing the handle through opening.

The membrane disc is perpendicular to the longitudinal axis line or protrudes into the cavity portion.

In the most preferred embodiment the membrane disc is positioned in the cavity portion in the middle third of the distance between the handle through opening and the through opening.

The diameter of the through opening of the outer cover is larger than the diameter of the membrane through opening,

The fixing end element preferably has a washer disc.

There is an embossed surface element on the outer cover, protruding from the surface thereof.

The outer cover of the dosed cell portion has scent openings with a diameter of maximum 10 percent of that of the handle through opening.

The membrane disc dog toy is illustrated in the following figures:

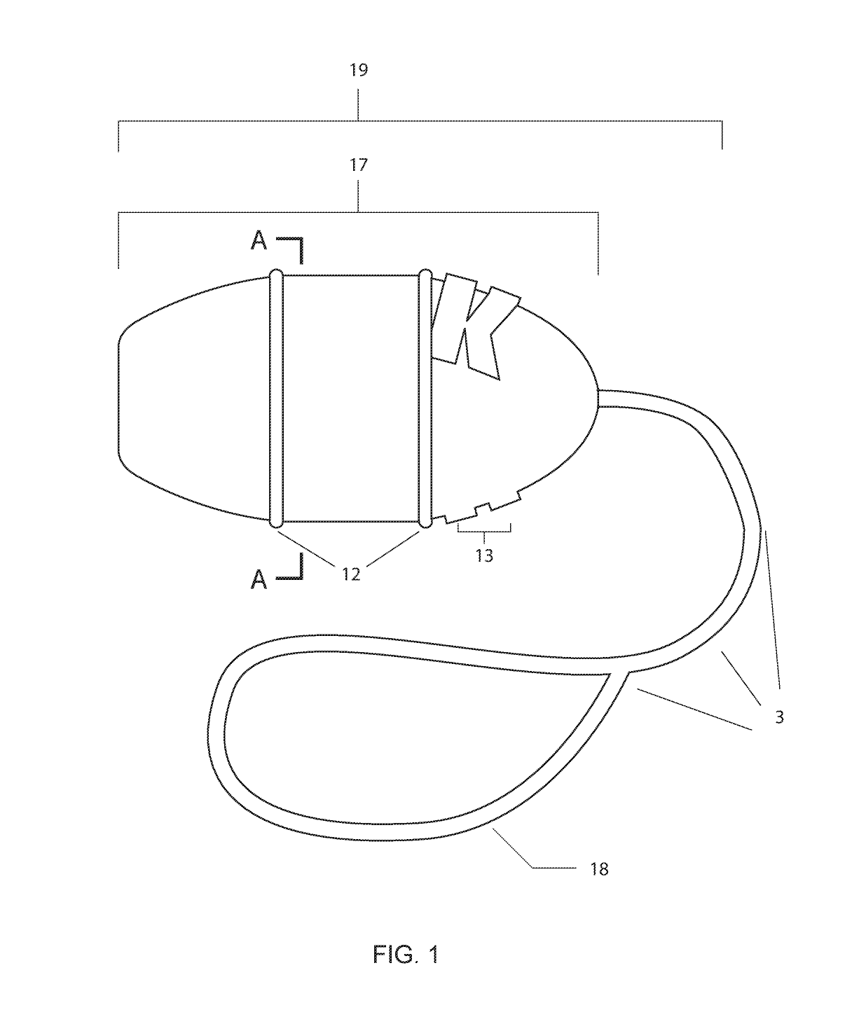

FIG. 1 shows a side view of the membrane disc dog toy with a barrel-shaped bite body and a handle

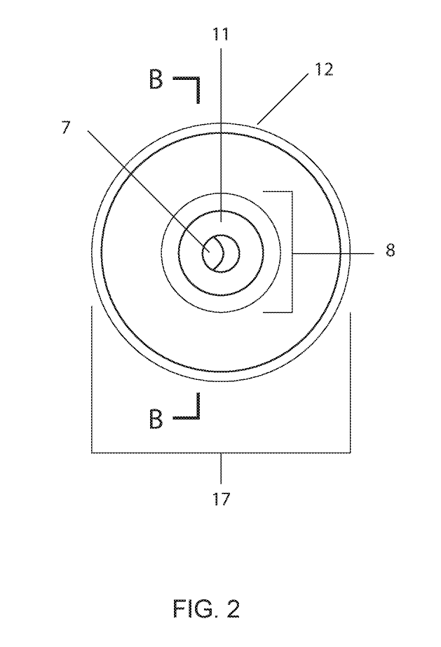

FIG. 2 shows the membrane disc dog toy from the direction of the through opening

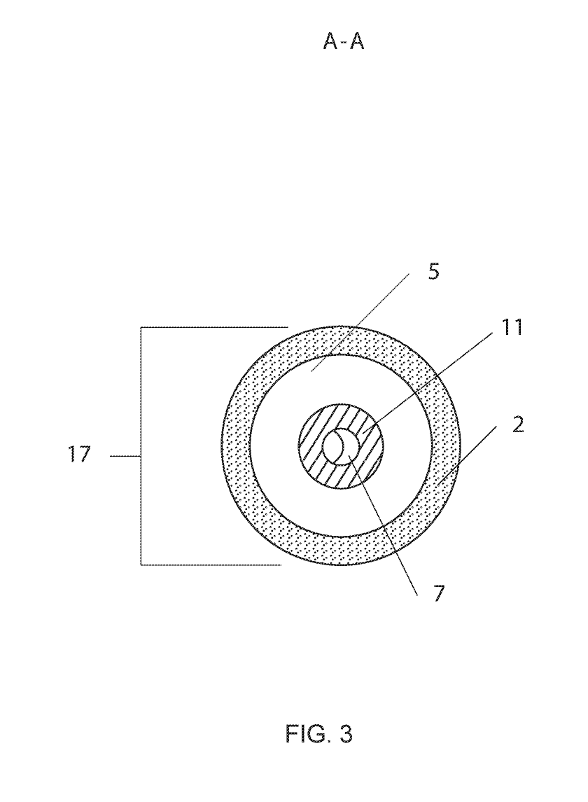

FIG. 3 shows the A-A cross-section of the outer cover and the membrane disc connected to it in the continuation thereof, and the preferred position of the fixing end element and the washer

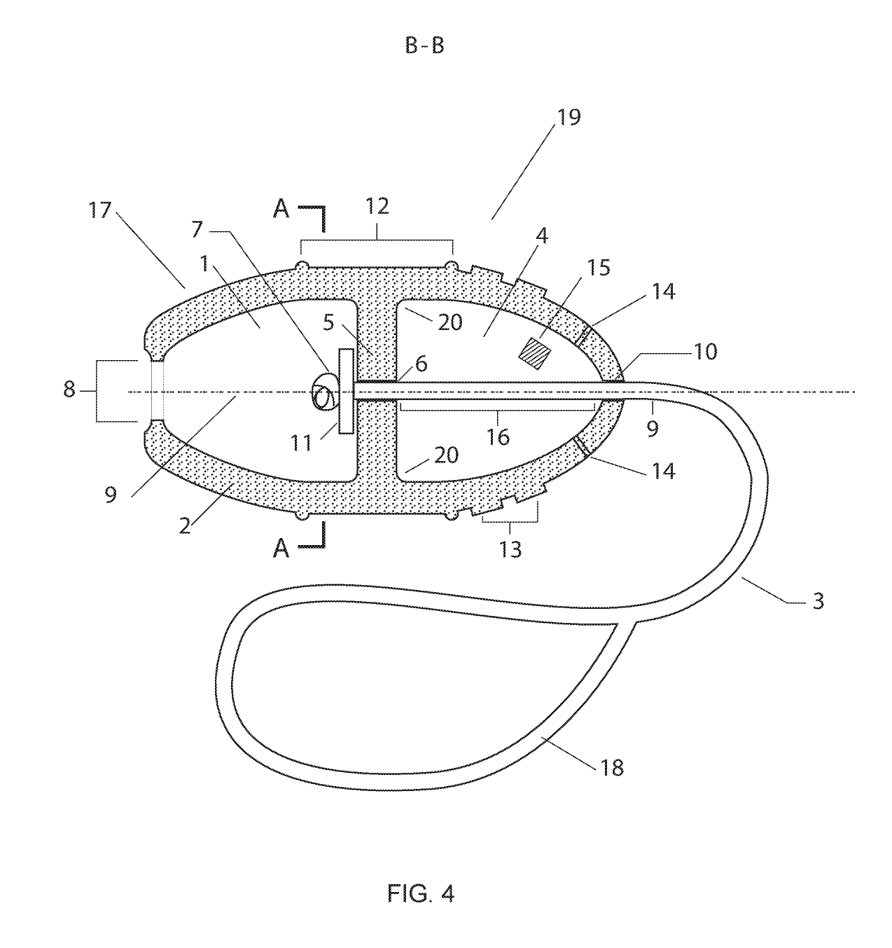

FIG. 4 shows the B-B cross-section of the main elements of the bite body, within that the dosed cell portion and the variable length handle portion, and their relationship to the handle

FIG. 1 shows the membrane disc dog toy 19 comprising a bite body 17 and a handle 3, preferably in the shape of an elongated sphere/a barrel wider in the middle. The handle 3 is preferably a string or strap extending beyond the bite body 17. The handle 3 ends in a gripping end element 18, which is a loop or other grip made by thickening the material.

The handle 3 extends beyond at least one side of the bite body 17. On the surface of the bite body 17 there is an embossed surface element 13 showing graphic elements or a logo.

On the bite body 17 there are at least two guide strips 12 facilitating its fixing with a fixing strap or a hook and loop fastener, running around the entire surface of the bite body 17.

FIG. 2 shows the bite body 17 from the side opposite to the handle 3 shown in FIG. 1, where there is a through opening 8. The diameter of the through opening 8 is equal to or larger than the fixing end element 7. The fixing end element 7 is preferably a knot formed from the handle 3 shown in FIG. 1, reinforced most preferably with a washer 11. The diameter of the washer 11 is larger than the diameter of the through opening 8. The washer 11 is preferably made of plastic.

FIG. 3 shows the A-A cross-section of the bite body 17 shown in FIGS. 1 and 2. The membrane disc 5 is formed from the outer cover 2, in the continuation thereof, by the confluence of materials. There is a washer 11 under the fixing end element 7 on the side towards the membrane disc 5, which is preferably made of plastic. The bite body 17 most preferably has an elongated sphere or sphere shape.

FIG. 4 shows the B-B cross-section of the most preferred embodiment of the membrane disc dog toy 19 comprising a bite body 17 and a handle 3 fixed inside it. The bite body 17 comprises a cavity portion 1 covered by an outer cover 2. A membrane disc 5 covered by the outer cover 2 separates a closed cell portion 4 from the cavity portion 1. In the most preferred embodiment the thickness of the membrane disc 5 differs from the thickness of the outer cover 2 by maximum 20%, and ensures the elasticity of the outer cover 2 against the forces acting perpendicularly to the longitudinal axis line 9.

The membrane disc 5 and the outer cover 2 are connected in a connecting portion 20 in an curved manner by the confluence of materials. The membrane disc 5 is perpendicular to the longitudinal axis line 9 or extends towards the cavity portion 1, peaking at the membrane through opening 6. The volume of the closed cell portion 4 and that of the cavity portion 1 preferably differ by 20%. The closed cell portion 4 has at least two openings, a membrane through opening 6 into the cavity portion 1 and a handle through opening 10. In the most preferred embodiment the diameter of the membrane through opening 6 and that of the handle through opening 10 are equal, and they are filled by the handle 3 passing through them. The diameter of the closed cell portion 4 perpendicular to the longitudinal axis line 9 is larger in the line of the membrane disc 5 than the diameter of the closed cell portion 4 on the side opposite to the membrane disc 5, containing the handle through opening 10. The membrane through opening 6 is covered on the side towards the cavity portion 1 by the fixing end element 7 of the handle 3 and the washer 11. The washer 11 is preferably made of plastic, and the handle 3 ending in a variably length handle portion 16 in the continuation thereof is led through it. The variable length handle portion 16 connects the membrane through opening 6 and the handle through opening 10 along the longitudinal axis line 9. The handle 3 comprises a fixing end element 7, a washer 11, a variable length handle portion 16 and a gripping end element 18. The longitudinal axis line 9 passes through the through opening 8 of the cavity portion 1, the membrane through opening 6 and the handle through opening 10. The membrane disc 5 is formed from the outer cover 2, in the continuation thereof. The membrane disc 5 is connected to the outer cover 2 in a connecting portion 20 by the confluence of materials. The connecting portion 20 is curved. Most preferably the membrane disc 5 is thicker than the outer cover 2, thereby material can be saved, The membrane disc 5 is most preferably perpendicular to the longitudinal axis line 9. Preferably, a freely moving object 15, a magnet or a scent-containing material is placed in the closed cell portion 4. There are scent openings 14 known from the prior art in the outer cover 2 covering the closed cell portion 4, to enhance evaporation from a scent-containing object 15. There is an embossed surface element 13 and/or guide strip 12 on the surface of the outer cover 2 on the side opposite to the cavity portion 1 and/or the closed cell portion 4.

The membrane disc dog toy covered by the utility model allows not only ordinary dog owners, but also physically and/or mentally disabled people or minors to perform instinct and skill development exercises with their dog. The movement of the membrane disc compensates for the lack of dog training expertise and develops the play instinct, predatory instinct of the dog. Due to the membrane disc, a tug-of-war game enjoyable for the dog requires no prior experience at all. By means of the membrane disc, the shock caused to the person holding the toy by the micro-vibrations resulting from the pulling force of the dog, acting on the joints of the wrist, elbow, shoulder, hip and spine, can be eliminated during the exercises. The device is suitable for allowing physically disabled, physically weak, or mentally disabled people to play with dogs. The design, material of the membrane greatly influences the stretching, and thus the micro-vibration damping capacity. The risk of the handle or the fixing end element being torn out while playing is reduced to the minimum by the fact that the fixing end element is held not directly by the outer cover, but by the membrane disc covered by the outer cover. The outer cover has no direct function in withstanding the pulling force, it only limits the stretching of the membrane disc. The membrane disc, by stiffening the outer cover perpendicularly to the longitudinal axis line, prevents the permanent deformation of the bite body. This allows the safe and long-term use of the membrane disc dog toy.

### List of Reference Numbers

1) cavity portion

2) outer cover

3) handle

4) dosed cell portion

5) membrane disc

6) membrane through opening

7) fixing end dement

8) through opening

9) longitudinal axis line

10) handle through opening

11) washer

12) guide strip

13) embossed surface element

14) scent opening

15) object

16) variable length handle portion

17) bite body

18) gripping end dement

19) membrane disc dog toy

20) connecting portion

1. A membrane disc dog toy comprising a handle and an elastic bite body, where the contour of said bite body is defined by an outer cover directly exposed to the bite of the dog, and said bite body comprises a cavity portion having at least one through opening and a handle through opening around the longitudinal axis line, and said handle extending beyond the outer cover has a fixing end element fixed in the cavity portion, wherein a membrane disc (5) is formed from the outer cover (2), fully covered by the outer cover (2), connected to the outer cover (2) in a connecting portion (20) in a curved manner by the confluence of materials, supporting the outer cover (2), and said membrane disc (5) separates a closed cell portion (4) from the cavity portion (1) on the side towards the handle through opening (10), furthermore there is a membrane through opening (6) in the membrane disc (5) around the longitudinal axis line (9), which is connected with the handle through opening (10) on the opposite side of the closed cell portion (4) around the longitudinal axis line (9) by a variable length handle portion (16) of the handle (3) of the membrane disc dog toy (19) passing through the closed cell portion (4) in the direction of the longitudinal axis line (9), furthermore the variable length handle portion (16) is led through the membrane through opening (6) and ends in a fixing end element (7) covering the membrane through opening (6) on the side towards the cavity portion (1), furthermore the membrane disc (5) stretches in the direction of the handle through opening (10) as a function of the pulling force acting on the handle (3), and the maximum stretching of the membrane disc (5) in the closed cell portion (4) is limited by the surface towards the closed cell portion (4) of the outer cover (2) towards the handle through opening (10), furthermore the membrane disc (5) controls the compression of the closed cell portion (4) and the cavity portion (1) in the direction perpendicular to the longitudinal axis line (9), elastically preventing their permanent deformation.

2. The membrane disc dog toy according to claim 1, wherein the diameter of the closed cell portion (4) perpendicular to the longitudinal axis line (9) is larger in the line of the membrane disc (5) than the diameter of the closed cell portion (4) on the side opposite to the membrane disc (5), containing the handle through opening (10).

3. The membrane disc dog toy according to claim 1, wherein the membrane disc (5) is perpendicular to the longitudinal axis line (9) or protrudes into the cavity portion (1).

4. The membrane disc dog toy according to claim 1, wherein in the membrane disc (5) is positioned in the cavity portion (1) in the middle third of the distance between the handle through opening (10) and the through opening (8).

5. The membrane disc dog toy according to claim 1, wherein the diameter of the through opening (8) of the outer cover (2) is larger than the diameter of the membrane through opening (6).

6. The membrane disc dog toy according to claim 1, wherein the fixing end element (7) has a washer disc (11).

7. The membrane disc dog toy according to claim 1, wherein there is an embossed surface element (13) on the outer cover (2), protruding from the surface thereof.

8. The membrane disc dog toy according to claim 1, wherein the outer cover (2) of the closed cell portion (4) has scent openings (14) with a diameter of maximum 10 percent of that of the handle through opening (10).

9. The membrane disc dog toy according to claim 2, wherein the membrane disc (5) is perpendicular to the longitudinal axis line (9) or protrudes into the cavity portion (1).

10. The membrane disc dog toy according to claim 2, wherein the membrane disc (5) is positioned in the cavity portion (1) in the middle third of the distance between the handle through opening (10) and the through opening (8).

11. The membrane disc dog toy according to claim 3, wherein the membrane disc (5) is positioned in the cavity portion (1) in the middle third of the distance between the handle through opening (10) and the through opening (8).

12. The membrane disc dog toy according to claim 9, wherein the membrane disc (5) is positioned in the cavity portion (1) in the middle third of the distance between the handle through opening (10) and the through opening (8).

13. The membrane disc dog toy according to claim 2, wherein the diameter of the through opening (8) of the outer cover (2) is larger than the diameter of the membrane through opening (6).

14. The membrane disc dog toy according to claim 3, wherein the diameter of the through opening (8) of the outer cover (2) is larger than the diameter of the membrane through opening (6).

15. The membrane disc dog toy according to claim 9, wherein the diameter of the through opening (8) of the outer cover (2) is larger than the diameter of the membrane through opening (6).

16. The membrane disc dog toy according to claim 4, wherein the diameter of the through opening (8) of the outer cover (2) is larger than the diameter of the membrane through opening (6).

17. The membrane disc dog toy according to claim 10, wherein the diameter of the through opening (8) of the outer cover (2) is larger than the diameter of the membrane through opening (6).

18. The membrane disc dog toy according to claim 11, wherein the diameter of the through opening (8) of the outer cover (2) is larger than the diameter of the membrane through opening (6).

19. The membrane disc dog toy according to claim 12, wherein the diameter of the through opening (8) of the outer cover (2) is larger than the diameter of the membrane through opening (6).

20. The membrane disc dog toy according to claim 2, wherein the fixing end element (7) has a washer disc (11).
